(19) United States
(12) Patent Application Publication
(10) Pub. No.: US 2012/0135274 A1
(43) Pub. Date: May 31, 2012

(54) NON-HCP MAGNETIC LAYER

(76) Inventors: CHUN WANG, Fremont, CA (US); Connie Liu, San Jose, CA (US); Xiaoding Ma, Fremont, CA (US); Li Tang, Fremont, CA (US); Kueir-Weei Chour, San Jose, CA (US)

(21) Appl. No.: 12/957,372

(22) Filed: Nov. 30, 2010

(51) Int. Cl. G11B 5/66; B05D 5/12

(52) U.S. Cl. 428/828.1; 427/131; 428/800; 428/827

(57) ABSTRACT

A magnetic film or layer includes a non-hexagonal close pack (non-hcp) structure.

### BACKGROUND

1. Field

Magnetic films or layers having a non-hexagonal close pack (non-hcp) structure are provided.

2. Background

Major magnetic layers may have a hexagonal close packing (hcp) crystal structure. The hcp structure has an easy slip plane of {0002}. The media may be vulnerable to scratch damage from collisions between the recording head and the media surface, due to fly height of the head.

### SUMMARY

In one aspect of the disclosure, an apparatus includes a substrate, a first magnetic layer having magnetic grains oriented perpendicular to said substrate, and a non-hexagonal close pack magnetic material capping layer over said first magnetic layer.

In another aspect of the disclosure, a recording medium includes a substrate, and at least one of a first magnetic layer and at least one of a non-magnetic thin film layer disposed on the substrate, wherein the at least one of a first magnetic layer includes a thin film non-hexagonal close pack magnetic material capping layer.

In a further aspect of the disclosure, a method of making magnetic media includes providing a substrate, and depositing on the substrate a plurality of magnetic and non-magnetic layers, wherein at least one of the layers comprises a thin film non-hexagonal close pack magnetic material capping layer.

### BRIEF DESCRIPTION OF THE DRAWINGS

FIG. 1 shows a perpendicular recording media structure;

FIG. 2 illustrates the close-packed (0002) plane of HCP Co and close-packed (111) plane of FCC Ni according to an embodiment;

FIG. 3 is a graph showing the effect of the thickness of the non-hcp capping layer on the thermal stability of recording media according to an embodiment;

FIG. 4 is a graph showing the effect of the thickness of the non-hcp capping layer on the critical load limit of recording media according to an embodiment;

FIG. 5 is a graph showing the effect of the thickness of the non-hcp capping layer on the scratch depth of recording media according to an embodiment; and

FIG. 6 is a graph showing the effect of the thickness of the non-hcp capping layer on the bit error rate of recording media containing said layer, as compared to media without non-hcp capping layer.

### DETAILED DESCRIPTION

Various apparatus, compounds and methods are described more fully hereinafter with reference to the accompanying drawings, in which various configurations are shown. These apparatus, compounds and methods, however, may be embodied in many different forms and should not be construed as limited to the various configurations presented throughout this disclosure. Rather, these configurations are provided so that this disclosure will be thorough and complete. The various aspects of these apparatus, compounds and methods illustrated in the drawings may not be drawn to scale. Rather, the dimensions of the various features may be expanded or reduced for clarity. In addition, some of the drawings may be simplified for clarity.

Various apparatus, compounds and methods will be described herein with reference to drawings that are conceptual illustrations of various configurations. As such, variations from the conceptual illustrations are to be expected in practice. By way of example, various elements such regions, layers, sections, or the like of a storage medium may be illustrated or described as a rectangle may have rounded or curved features and/or a gradient concentration at its edges rather than a discrete change from one element to another. Thus, the elements illustrated in the drawings are conceptual in nature and not intended to limit the scope of the present invention.

It will be understood that when an element such as a region, layer, section, or the like, is referred to as being “on” or “over” another element, it can be in direct contact with the other element or intervening elements may also be present. It will be further understood that when an element is referred to as being “formed” on another element, it can be grown, deposited, etched, attached, connected, coupled, or otherwise prepared or fabricated on the other element or an intervening element.

Furthermore, an element such as a region, layer, section, or the like, may be illustrated as being above or below another element to describe one element's relationship to another element. It will be understood that relative terms are intended to encompass different orientations of an apparatus in addition to the orientation depicted in the drawings. By way of example, if an apparatus depicted in a drawing is turned over, elements described as being above are now below, and vice versa.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Methods of optimizing scratch resistance, for example in the recording media, are provided. The methods generally comprise applying the compositions to the apparatus as it is being formed. Compositions for providing scratch resistance to apparatus are also provided. Apparatus incorporating the compositions are also provided.

### Apparatus

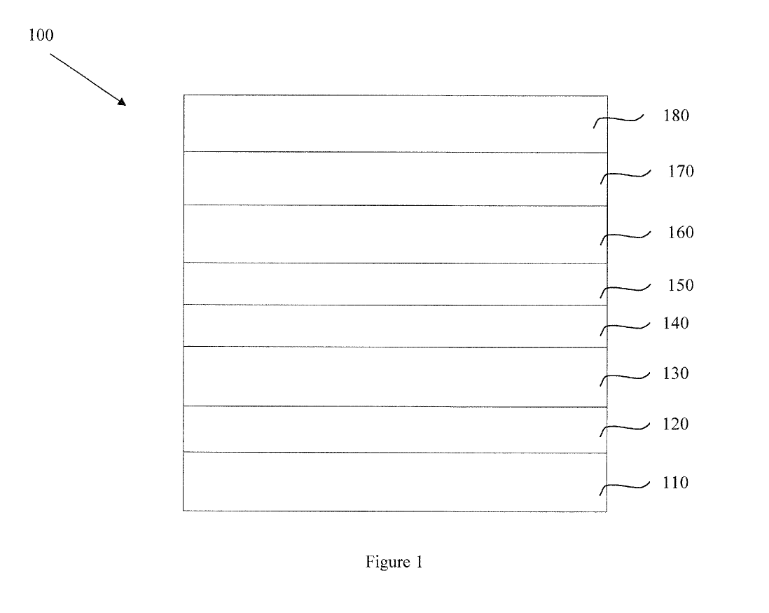

FIG. 1 shows an embodiment of a perpendicular recording media structure 100 in accordance with the disclosure. The structure 100 includes a substrate 110, an optional adhesion layer 120, a magnetically-soft underlayer (SUL) 130, an optional seed layer 140, one or more optional interlayers 150, a magnetic layer 160, a capping layer 170, and a carbon overcoat (COC) layer 180. The recording media may also optionally incorporate a lubricant layer.

A perpendicular recording medium 100 may comprise a plurality of film layers deposited on a non-magnetic disk substrate 110, such as glass, aluminum (Al), or an Al-based alloy.

A magnetically soft underlayer (SUL) 130 is provided on the substrate, i.e., a magnetic layer having a relatively low coercivity, typically not greater than about 1 kOe, such as of a NiFe alloy (Permalloy). The SUL 130 may be relatively thick, as compared with the magnetic recording layer. An optional adhesion layer 120 may be provided between the substrate 110 and the SUL 130.

“Intermediate” layers 150 may be provided on the SUL 130. These may include at least one non-magnetic interlayer of an hcp material adjacent a magnetically-hard perpendicular recording layer, and an optional seed layer 140 adjacent the magnetically soft underlayer (SUL) 130. When provided, the seed layer 140 may comprise at least one of an amorphous material, a material having a body-centered cubic (bcc) crystal structure, and a material having a face-centered cubic (fcc) structure. The seed layer 140 may serve to preferentially order growth of the subsequent layers.

A magnetically “hard” recording layer 160 is provided on the SUL 130 and optional intermediate layers 150 and seed layer 140. The magnetically “hard” recording layer 160 may have a relatively high coercivity, typically about 3-8 kOe, and may be formed from a cobalt-based alloy (e.g., a Co—Cr alloy such as CoCrPtB) having perpendicular anisotropy.

At least one capping layer 170 may be provided on the recording layer 160, with the magnetic easy axis of the recording layer 160 perpendicular to the substrate plane. The capping layer 170 may be relatively thin (as compared to the recording layer 160). The capping layer 170 may also be a magnetically-hard layer.

The order of these layers may be varied to provide other configurations. Regardless of the particular configuration of the underlying layers, a carbon overcoat layer 180 and a lubricant layer (not shown) may also be included for protection of the underlying layers.

It may be appreciated that the adaptation of recording media, including HDD systems, to include the non-hcp magnetic capping layer described herein, can provide performance and reliability over recording media that incorporate hcp magnetic capping layer materials.

### Compositions

The apparatus 100 include a substrate 110, which may be formed using glass, glass ceramics, aluminum (Al), or Al-based alloys or other suitable material.

The adhesion layer 120 may be a nickel-based coating provided on the substrate 110. One adhesion layer is NiP, which may be applied as a coating on the substrate. However, the adhesion layer 120 provided on the substrate 110 could be any type of Ni-containing layer, such as a NiNb layer, a Cr/NiNb layer, or another Ni-containing layer.

The apparatus 100 also includes a magnetic soft underlayer (SUL) 130, or alternatively, an antiferromagnetically-coupled (AFC) layer, between the substrate 110 and the magnetic layer 160 (where the SUL 130 and the substrate 110 may optionally be separated by an adhesion layer 120, and where the SUL 130 and the magnetic layer 160 may optionally be separated by one or more seed layers 140 and interlayers 150). Soft underlayer (SUL) 130 may have any of a number of different designs, including a single SUL, anti-ferromagnetic coupled (AFC) structure, laminated SUL, SUL with pinned layer (also called anti-ferromagnetic exchange biased layer), and so on. Examples of SUL materials include FeₓCo_{y}B_{z} based, and CoₓZr_{y}Nb_{z}/Co_{z}Zr_{y}Ta_{z} based materials. The SUL according to present invention may be amorphous or nanocrystalline, and can be formed from a material such as FeCoB, FeCoC, FeCoTaZr, FeTaC, FeSi, CoZrNb, CoZrTa, etc. The thickness of the SUL may be from about 100 Å to about 5000 Å, and more preferably be from about 600 Å to about 2000 Å thick. More than one soft underlayer may be provided.

The seed layers 140 may be formed from a Ni alloy having the composition Ni₁₀₀₋ₓMₓ, where M is a metal selected from V, Cr, W, Al, and Ta, and x has a value such that the Ni-alloy maintains a crystalline structure. In this embodiment x may have a value of from about 0 to about 50. The thickness of the seed layer may be in the range of 5 Å to 200 Å.

The interlayers 150 may include, for example, Ru-based materials.

The magnetic layer 160, which may be formed from a magnetic alloy containing cobalt (Co), may be granular, and may comprise one or more Co-based continuous magnetic layers. The magnetic alloy of the magnetic layer may also contain platinum (Pt) or chromium (Cr). The magnetic layer may be provided in the form of a thin film deposited on top of the SUL 130, or on top of the one or more optional seed layers 140 and interlayers 150. Furthermore, the magnetic alloy include other combinations of B, Cr, Co, Pt, Ni, Al, Si, Zr, Hf, W, C, Mo, Ru, Ta, Nb, O and N. The thickness of the magnetic layer is from about 50 Å to about 300 Å, more preferably from about 80 Å to about 150 Å.

The capping layer 170 may be a magnetically-hard layer, and may be formed from a perpendicular magnetic material. The capping layer 170 may be formed from an amorphous material, a material having a body-centered cubic (bcc) crystal structure, or a material having a face-centered cubic (fcc) structure. The capping layer 170 may be in the form of a thin film layer of a non-hcp magnetic material, and may be provided in addition to the standard magnetic media structure that improves scratch robustness. The non-hcp magnetic capping layer can be formed from soft magnetic materials or hard magnetic materials such as Ni alloys, NiCo alloys, Fe alloys, NiFe alloys, Fe alloy, Co₁₀₀₋ₓPtₓ or amorphous magnetic materials. The insertion of non-hcp magnetic layer is not limited to the top position. It may be added to any position above the main granular magnetic layers.

The capping layer 170 comprises a Ni alloy having the general formula Ni₁₀₀₋ₓ Mₓ, where M may include, but is not limited to, a metal selected from V, Cr, W, Al, and Ta, and x has a value such that the Ni-alloy maintains a FCC crystalline structure. X may be, for example, 0 to 50. M is W and x is less than or equal to 6. When M is W, and x is less than or equal to 6, the magnetic property of the layer is maintained. The epitaxial growth relationship between Ni₁₀₀₋ₓWₓ and the hcp magnetic layer 150 is believed to result in the scratch robustness. One capping layer is formed from fcc Ni₁₀₀₋ₓWₓ, where x is 5.

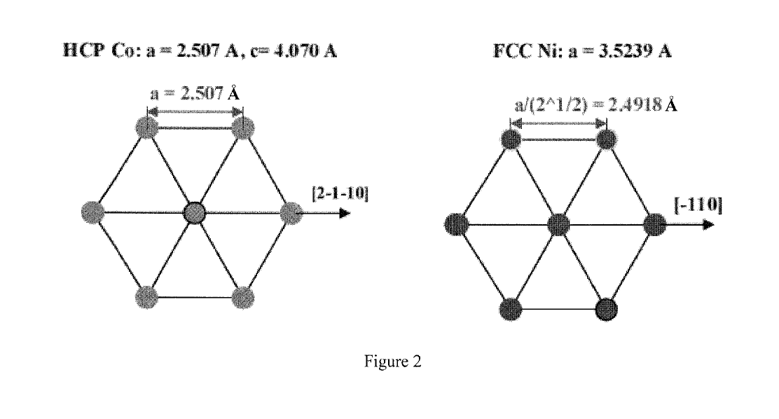

As shown in FIG. 2, the (111) plane lattice dimension of 2.4918 Å for Ni₁₀₀₋ₓWₓ closely resembles the (0002) plane lattice constant of 2.507 Å for Co-alloys. However, the plane 111 of the Ni₁₀₀₋ₓWₓ fcc structure is more resistant to head damage, such as scratches, than the (0002) plane of an hcp structure, which provides improved protection to the magnetic recording layers below.

The thickness of the capping layer 170 may be in the range of from 0 Å to 100 Å, preferably from about 5 Å to about 40 Å.

The COC layer 180 is formed from carbon, and may also be overcoated with an optional lubricant layer (“lube”).

### Methods

Each of the layers constituting magnetic recording media 100, except for the carbon overcoat (COC) 180 and lubricant layers, may be deposited or otherwise formed by any suitable physical vapor deposition technique (PVD), e.g., sputtering, or by a combination of PVD techniques, i.e., sputtering, vacuum evaporation. The COC 180 is typically deposited by sputtering or ion beam deposition. The lubricant layer is typically provided as a topcoat by dipping the medium into a bath containing a solution of the lubricant compound, followed by removal of excess liquid, such as by wiping, or by a vapor lube deposition method in a vacuum environment.

There are two types of sputtering: pass-by sputtering and static sputtering. In pass-by sputtering, disks are passed inside a vacuum chamber, where they are deposited with the magnetic and non-magnetic materials that are deposited as one or more layers on the substrate when the disks are moving. Static sputtering uses smaller machines, and each disk is picked up and deposited individually when the disks are not moving.

The sputtered layers are deposited in what are called bombs, which are loaded onto the sputtering machine. The bombs are vacuum chambers with targets on either side. The substrate is lifted into the bomb and is deposited with material to be sputtered. Sputtering leads to formation of some particulates on the coated substrate. These particulates to be removed to ensure that they do not lead to scratching between the head and substrate.

Once the layer of lube is applied, the coated substrates are buffed, where the substrate is polished while it spins around a spindle. The substrate is wiped and a clean lube is evenly applied on the surface.

These and other aspects of the invention are further described in the non-limiting Example set forth below.

### Example

A recording media having a capping layer that comprises a nickel alloy of Ni₉₅W₅ was tested. Mechanical performance was measured as a function of increasing Ni₉₅W₅ layer thickness, from 0 to 40 Å.

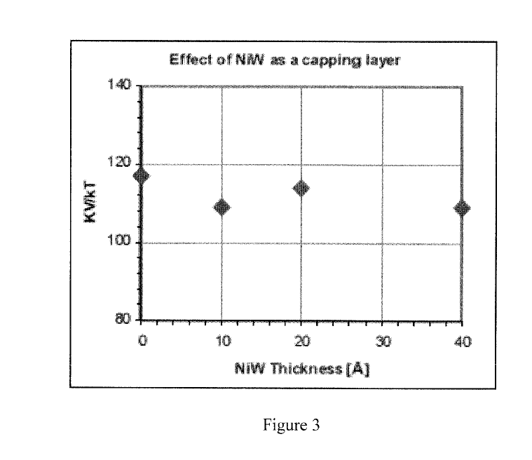

FIG. 3 is a plot of thermal stability (KuV/kT) as a function of layer thickness, showing that thermal stability remains substantially constant over the measured range of Ni₉₅W₅ thickness.

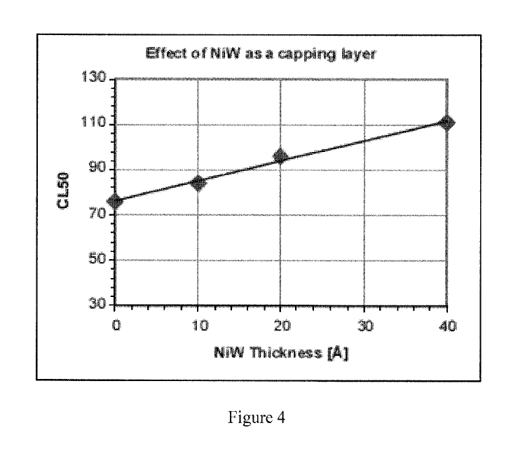

FIG. 4 shows the test results of the thickness effect of Ni₉₅W₅ on CL50 of the perpendicular magnetic media. A critical load limit, CL50, is when a magnetic force microscope (MFM) signal is reduced 50%. Measuring the critical load limit indicates the media scratch robustness. Higher CL50 value means better media scratch performance. As shown in FIG. 4, it was found that CL50 significantly with the increase of Ni₉₅W₅ thickness. The CL50 value, measured in micro Newtons μN, increase log linearly with the capping layer thickness. The CL50 increased from 75 μN to 110 μN when Ni₉₅W₅ thickness changed from 0 to 40 Å. Thus, CL50 increased by about 10 μN when Ni₉₅W₅ thickness was increased by 10 Å.

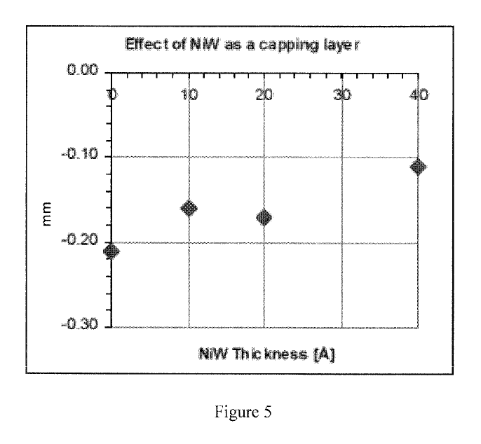

FIG. 5 shows the Ni₉₅W₅ thickness effect on the scratch depth of the perpendicular magnetic media. As shown in FIG. 5, the scratch depth reduced from 0.2 mm to 0.1 mm as Ni₉₅W₅ thickness increased from zero to 40 nm.

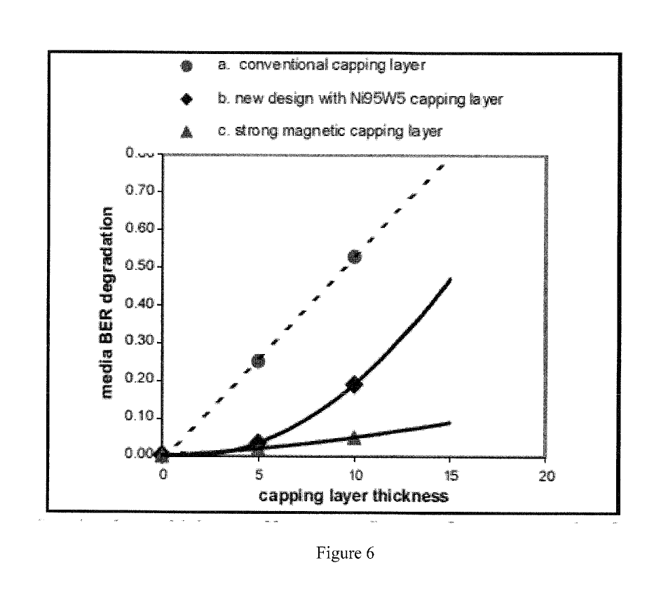

FIG. 6 shows the electrical measurement of media with a nonmagnetic capping layer such as carbon compared with capping layer comprising Ni₉₅W₅ over a range of thicknesses. The bit error rate (BER) degrades log linearly with increasing carbon layer thickness. In comparison, the degradation is much less with Ni₉₅W₅. As shown in FIG. 6, with the nonmagnetic carbon layer, the BER degrades by 0.55 decades with a 10 Å additional thickness. By comparison, with Ni₉₅W₅ layer, the BER degrades by 0.2 decade with 10 Å additional thickness. The cause of the increased BER degradation with the nonmagnetic capping layer is due to the HKS loss, therefore, resulting in a weaker write field. By comparison, with a Ni alloy fcc magnetic capping layer design, loss due to HKS loss is reduced and BER is good.

The various aspects of apparatus, compounds and methods are presented throughout this disclosure. Various changes, alterations, modifications to the apparatus, compounds and methods presented will be readily apparent to those skilled in the art, and the concepts disclosed herein may be extended to other apparatus, compounds and methods. Thus, the claims are not intended to be limited to the various aspects of this disclosure, but are to be accorded the full scope consistent with the language of the claims. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus comprising;
a substrate;
a first magnetic layer having magnetic grains oriented perpendicular to said substrate; and
a non-hexagonal close pack magnetic material capping layer over said first magnetic layer.

2. The apparatus of claim 1, wherein the non-hexagonal close pack magnetic material capping layer is selected from the group consisting of body centered cubic and face centered cubic crystalline materials.

3. The apparatus of claim 1, wherein the non-hexagonal close pack magnetic material capping layer comprises a Ni alloy.

4. The apparatus of claim 3, wherein the Ni alloy comprises NiW.

5. The apparatus of claim 1, wherein the substrate is non-magnetic.

6. The apparatus of claim 1, further comprising:
a second magnetic layer over the substrate selected from the group consisting of a magnetic soft underlayer (SUL) and an antiferromagnetically-coupled (AFC) layer, wherein the second magnetic layer is between the first magnetic layer and the substrate.

7. The apparatus of claim 6, further comprising an adhesive layer interposed between the substrate and the second magnetic layer.

8. The apparatus of claim 6, further comprising one or more interlayers between the second magnetic layer and the first magnetic layer.

9. The apparatus of claim 6, further comprising a seed layer interposed between the second magnetic layer and the first magnetic layer.

10. A recording medium comprising:
a substrate; and
at least one of a first magnetic layer and at least one of a non-magnetic thin film layer disposed on the substrate,
wherein the at least one of a first magnetic layer includes a thin film non-hexagonal close pack magnetic material capping layer.

11. The apparatus of claim 10, wherein the non-hexagonal close pack magnetic material capping layer is selected from the group consisting of body centered cubic and face centered cubic crystalline materials.

12. The apparatus of claim 10, wherein the non-hexagonal close pack magnetic material capping layer comprises a Ni alloy.

13. The apparatus of claim 12, wherein the Ni alloy comprises NiW.

14. The apparatus of claim 10 further comprising,
a second magnetic layer selected from the group consisting of a magnetic soft underlayer (SUL) and an antiferromagnetically-coupled (AFC) layer is over the substrate, wherein first magnetic layer is over the second magnetic layer.

15. The apparatus of claim 14, further comprising an adhesive layer interposed between the non-magnetic substrate and the second magnetic layer.

16. The apparatus of claim 14, further comprising one or more interlayers between the second magnetic layer and the first magnetic layer.

17. The apparatus of claim 14, further comprising a seed layer interposed between the second magnetic layer and the first magnetic layer.

18. A method of making magnetic media, comprising:
providing a substrate; and
depositing on the substrate a plurality of magnetic and non-magnetic layers,
wherein at least one of the layers comprises a thin film non-hexagonal close pack magnetic material capping layer.

19. The method of claim 18, wherein the non-hexagonal close pack magnetic material capping layer is selected from the group consisting of body centered cubic and face centered cubic crystalline materials.

20. The method of claim 18, wherein the non-hexagonal close pack magnetic material capping layer comprises a Ni alloy.

21. The method of claim 20, wherein the Ni alloy comprises NiW.

22. The method of claim 18, further comprising:
depositing a second magnetic layer on the substrate selected from the group consisting of a magnetic soft underlayer (SUL) and an antiferromagnetically-coupled (AFC) layer;
depositing a first magnetic layer on the second magnetic layer;
depositing the non-hexagonal close pack magnetic material capping layer on the first magnetic layer; and
depositing a carbon overcoat layer on the non-hexagonal close pack magnetic material capping layer.

23. The method of claim 22, further comprising forming an adhesive layer interposed between the substrate and the second layer.

24. The method of claim 22, further comprising depositing a seed layer interposed between the second magnetic layer and the first magnetic layer.

25. The method of claim 22, further comprising depositing one or more interlayers between the second magnetic layer and the first magnetic layer.
